(19) United States
(12) Patent Application Publication
(10) Pub. No.: US 2022/0266552 A1
(43) Pub. Date: Aug. 25, 2022

(54) METHOD FOR REPAIRING A FIBER COMPOSITE COMPONENT

(71) Applicants: Airbus Defence and Space GmbH, Taufkirchen (DE); Airbus Operations GmbH, Hamburg (DE)

(72) Inventors: Dirk Holzhüter, Braunschweig (DE); Jens KOSMANN, Braunschweig (DE); Thomas Körwien, Höhenkirchen (DE); Anton Maier, Pfeffenhausen (DE); Thomas Kruse-Strack, Herrmannsburg (DE)

(21) Appl. No.: 17/633,029

(22) PCT Filed: Aug. 6, 2020
(86) PCT No.: PCT/EP2020/072165

§ 371 Date: Feb. 4, 2022

(30) Foreign Application Priority Data
Aug. 7, 2019 (DE) 10 2019 121 357.6

(51) Int. Cl. B29C 73/10

(52) U.S. Cl. CPC B29C 73/10

(57) ABSTRACT

The invention relates to a method for repairing a damaged point of a fiber composite component which is formed from at least one fiber ply of a fiber material of a fiber composite substance and a matrix material of the fiber composite substance, in which matrix material the fiber material is embedded, wherein the method comprises the following steps:
removing the damaged point from the fiber composite component and producing a repair cavity in the fiber composite component,
introducing at least one reparative fiber ply of a fiber material into the repair cavity produced in the fiber composite component, and
curing the matrix material, in which the fiber material of the reparative fiber ply is embedded, after introducing the reparative fiber ply into the repair cavity of the fiber composite component,

wherein at least one reparative fiber ply having a ply thickness that is smaller than the ply thickness of the fiber plies of the rest of the fiber composite component is introduced into the repair cavity.

The invention relates to a method for repairing a damaged point of a fiber composite component which is formed or produced from at least one fiber ply of a fiber material of a fiber composite substance and a matrix material of the fiber composite substance, in which matrix material the fiber material is embedded.

On account of the weight-specific strength and rigidity, nowadays it is virtually impossible to dispense with fiber composite components produced from a fiber composite substance. Fiber composite substances, from which fiber composite components of this type can be produced, in this respect generally comprise two essential main constituent parts, specifically firstly a fiber material and secondly a matrix material in which the fiber material is embedded. The fiber material substantially confers its load-bearing properties in the direction of the reinforcing fibers on the fiber composite component produced from such a fiber composite substance. By curing the matrix material in which the fiber material is embedded, the reinforcing fibers are forced into the predefined load direction and thus form an integral unit together with the matrix material.

It is not just in the case of large-scale or large-area fiber composite components that they are constructed from multiple fiber plies of the fiber material in layers in the manner of a laminate, it being possible for the directions of the reinforcing fibers to differ from one fiber ply to another. Constructing a fiber laminate in ply form makes it possible to approximate an isotropic substance property in the component plane, since the direction of the reinforcing fibers now varies in accordance with the respective fiber plies. However, it is also possible to targetedly define anisotropic substance properties.

After the fiber laminate as fiber preform has been formed from the individual fiber plies of the fiber material, the matrix material in which the fiber material is embedded is usually cured with control of the temperature and application of pressure, with the result that the fiber material and the matrix material form an integral unit. In this respect, it is possible to use dry fiber materials which still have to be infused with the matrix material at a later point in time. Also known, however, are preimpregnated fiber materials, what are known as prepregs, in the case of which the matrix material has been introduced into the fiber material already before the fiber laminate or the fiber preform has been formed.

When using fiber composite components at exposed locations, for example as a hull for passenger aircraft, or else at other locations, it is frequently necessary to repair the fiber composite component during operation, if it exhibits a damaged point. Such a damaged point can arise as a result of the action of an object on the fiber composite component with a certain force, for example. In addition to damage to the reinforcing fibers of one or more fiber plies of the fiber composite component, such a damaged point can also exhibit phenomena in which individual fiber plies detach from one another and are no longer held together by the cured matrix material.

DE 10 2011 056 088 A1, for example, discloses a method for repairing a damaged point of a fiber composite component, wherein here a scarfing is introduced into the fiber composite component in the region of the damaged point in order firstly to remove the damaged fiber materials from the fiber composite component. Then, Z-pins are inserted in the region of the scarfing. Now, reparative fiber semifinished products, which are to be introduced into the scarfing and therefore fill in the damaged region of the fiber composite component, are draped around these Z-pins. The Z-pins are intended in this respect to create as great as possible a stability and rigidity of the repaired point.

A similar repair method is also known from U.S. Pat. No. 5,868,886, in which, in the region of the damaged point to be repaired, Z-pins are driven into the existing base structure of the fiber composite component using ultrasound.

When damaged points of this type are repaired by way of corresponding reparative fiber semifinished products, use is generally made of fiber semifinished products that correspond to the fiber semifinished products used for producing the fiber composite component. However, it has been shown that here large corrugations are produced on the component surface and furthermore the surface of the repair point usually no longer has a flush termination, this being attributable to the fact that the reparative fiber semifinished products used at the repair point, by contrast to when the entire fiber composite component is produced, cannot be subjected to a pressure so that the fiber volume content corresponds to the fiber volume content of the rest of the fiber composite component. This is because the use of a pressure furnace (autoclave) makes it possible, during the production of the fiber composite component, to apply a pressure to the surface of the fiber composite component from the outside, which pressure leads to the fiber plies being pressed together and thereby increases the fiber volume content. During the repair, the reparative fiber semifinished products used ought to be subjected to a pressure in the same or a similar way, this only being possible with difficulty in view of the fiber composite structure.

In addition, it has been shown that a large individual ply thickness causes the formation of regions of pure resin or adhesive, which do not contribute to the strength and typically constitute regions in which premature failure occurs.

It is therefore an object of the present invention to specify an improved method for repairing a damaged point of a fiber composite component in the case of which the repaired damaged point has a similar strength and rigidity to the rest of the fiber composite component and, furthermore, corrugations on the surface of the repaired damaged point and thickenings in the region of the damaged point can be avoided.

The object is achieved according to the invention by the method according to claim 1. In accordance with claim 1, a method for repairing a damaged point of a fiber composite component is proposed, wherein the fiber composite component is produced from a fiber composite substance. The fiber composite substance in the generic case comprises a fiber material and a matrix material, wherein the fiber material has been provided in the form of individual fiber plies. Accordingly, the fiber composite component is produced from at least one such fiber ply of the fiber material by curing the matrix material in which the fiber material is embedded. However, the fiber composite component will generally comprise a plurality of individual fiber plies, which are arranged one on top of the other in layers or in plies.

In the generic case, in this respect the method firstly comprises the step of removing the damaged point from the fiber composite component by producing a repair cavity in the fiber composite component. According to one embodiment, this may be effected in the form of a scarfing, in which the edges of the repair cavity are slanted toward the base of the cavity.

Then, at least one reparative fiber ply of a fiber material is introduced into the repair cavity produced in the fiber composite component, and then the matrix material in which the fiber material is embedded is consolidated (for example cured). In this respect, the matrix material may be the same matrix material which was also used to produce the fiber composite component. However, it is also conceivable to use another matrix material, which cures at lower temperatures, for example.

The reparative fiber plies may be introduced through the use of an additional adhesive, for example. The reparative fiber plies are then adhesively bonded into the repair cavity and/or adhesively bonded to one another. Here, the adhesive may have the same properties as the matrix material used or different properties, in order to be able to adapt the repair to the prevailing conditions.

Accordingly, the fiber composite component per se may be produced from a first fiber composite substance comprising a first fiber material and a first matrix material, whereas a second fiber composite substance comprising a second fiber material and a second matrix material is used for the repair. In this respect, the first matrix material and the second matrix material may be the same or differ from one another.

It is now provided according to the invention that at least one reparative fiber ply having a ply thickness that is smaller than the ply thickness of the fiber plies of the rest of the fiber composite component is introduced into the repair cavity. Accordingly, the fiber plies of the fiber composite component of the first fiber composite substance differ from the fiber plies of the fiber material of the second fiber composite substance in terms of the ply thickness in such a way that the ply thickness of the reparative fiber plies is smaller than the ply thickness of the fiber material of the fiber composite component. Different ply thicknesses may be used here. It is possible here for the reparative fiber plies to all have the same ply thickness, for only some of the reparative fiber plies to have the same ply thickness, or for all reparative fiber plies to have different ply thicknesses.

On account of the fact that in the case of a repair of this type within the repair cavity the ply structure no longer corresponds to the original ply structure of the fiber composite component, the repair patch located within the repair cavity can be adapted to the prevailing conditions much more precisely and flexibly. It has been shown here that the use of reparative fiber plies having a ply thickness that is smaller than the ply thickness of the fiber plies of the rest of the fiber composite component makes it possible to better adapt the repair rigidity, without adversely affecting the load-bearing properties of the entire component. Now, substantially smaller resin pockets and adhesive pockets form at the edges of the repair cavity, which results in a higher repair rigidity.

It has furthermore been shown that the surface corrugation can be reduced by the use of reparative fiber plies having a smaller ply thickness, this having an especially advantageous effect in particular in the case of flow surfaces around which a laminar flow can pass. On account of the reduced corrugation, in addition the compressive strength is increased. The use of reparative fiber plies having a ply thickness that is smaller than the ply thickness of the fiber plies makes it possible to reduce stress concentrations at the extensions of the plies (the original is smoothed out, the repair is discrete). This is because the repair cavity is generally scarfed, while the reparative fiber plies have a step-shaped form. The smaller ply thickness reduces stress concentrations owing to the graduated repair.

Moreover, multiple reparative fiber plies having a load-optimized ply orientation may be coupled to one fiber ply of the fiber composite component, as a result of which the mechanical properties of the repair are improved. In this respect, the smaller individual layer thickness reduces the local adhesive-induced loading and thus increases the strength of the connection. On account of the larger interface, the tolerance to damage is higher. Manufacturing-related variations in the overlap lengths may be equalized and compensated for through the use of reparative fiber plies having a smaller ply thickness.

According to one embodiment, the repair cavity is produced in the fiber composite component by forming a scarfing in the region of the damaged point.

The scarfing creates a type of repair cavity which runs conically toward the fiber composite component and into which the individual repair plies are then placed in plies.

According to one embodiment in this respect, the reparative fiber plies are arranged in a stepped manner in the repair cavity, with the result that the second reparative fiber ply, which is placed on a first reparative fiber ply, has a larger extent and at least one different direction than the underlying first reparative fiber ply. Accordingly, a ply structure of reparative fiber plies forms a step-shaped or stepped geometry, which does not correspond to the geometry of the repair cavity, at the ends of the plies (ply extenders). By reducing the individual layer thickness of the reparative fiber plies, the negative properties of the step-shaped or stepped geometry in the edge regions are reduced.

According to one embodiment, all of the reparative fiber plies introduced in the repair cavity are formed in such a way that they have a ply thickness which is smaller than the ply thickness of the fiber plies of the rest of the fiber composite component. Different ply thicknesses may be used here.

This ensures that the number of reparative fiber plies in the repair cavity is greater than the number of fiber plies of the fiber composite component which, as a result of producing the repair cavity, are impregnated and thus relevant.

According to a further embodiment, the at least one reparative fiber ply is already preimpregnated with a matrix material. In other words, at least one reparative fiber ply, preferably all of the reparative fiber plies, having a ply thickness that is smaller than the ply thickness of the fiber plies of the rest of the fiber composite component is what is known as a prepreg material. However, it is also conceivable that the reparative fiber plies are infused with a matrix material in an infusion process before or after they are placed in.

According to one embodiment, at least one of the reparative fiber plies has a ply thickness of less than 80%, preferably less than 60%, particularly preferably of less than 40%, of the ply thickness of the fiber plies of the rest of the fiber composite component. In the best case, it can therefore be achieved that one fiber ply of the fiber composite component is assigned or corresponds to at least 1½, preferably at least 2 or even more reparative fiber plies, which makes it possible to improve the repair rigidity.

According to one embodiment, at least one reparative fiber ply, preferably all of the reparative fiber plies, has a ply thickness of less than 100 g/m², preferably less than 75 g/m² and particularly preferably of less than 50 g/m².

By contrast, according to one embodiment, the fiber plies of the rest of the fiber composite component can have a ply thickness of more than 100 g/m², preferably more than 135 g/m².

According to one embodiment, the reparative fiber plies are introduced into the repair cavity in such a way that the second reparative fiber ply, which is placed on a first reparative fiber ply, has a main fiber direction which differs from the first reparative fiber ply. Accordingly, the direction of the reinforcing fibers (main fibers) differs between two reparative fiber plies that follow one another, with the result that in two successive reparative fiber plies the main fiber directions are different. On account of the fact that the reparative fiber plies are thinner than the fiber plies of the fiber composite component, in the repair cavity more than one reparative fiber ply is accordingly assigned to one fiber ply, reparative fiber plies having different fiber directions now being arranged in the plane of a fiber ply of the fiber composite component in the repair cavity. This considerably improves the strength and rigidity of the repair patch and the load-transferring properties within the repair patch in relation to a fiber ply. However, it is also possible for two reparative fiber plies having the same orientation to be placed one on top of the other.

According to one embodiment in this respect, the main fiber directions may differ by an angle of 45° or 90°. However, in principle, any desired angles may be used.

According to one embodiment, it is provided that one or more covering fiber plies (also referred to as cover ply) are placed onto the reparative fiber plies introduced in the repair cavity. As a result of this, the reparative fiber plies introduced in the repair cavity are covered by the covering fiber ply, improved load transfer of the repaired point additionally being achieved.

In this respect, it may be provided that at least one of the covering fiber plies, preferably the topmost covering fiber ply, has a larger extent than the repair cavity in at least one direction. At least one of the covering fiber plies preferably has an areal extent that is larger than the repair cavity on the surface of the fiber composite component. This ensures that this at least one covering fiber ply completely covers the repair cavity and in the process in particular overlaps the repair cavity in the edge region. In this respect, the reparative fiber plies may have a larger surface area than the repair cavity on the surface of the fiber composite component. In this case, it may be provided that this property applies to all of the covering fiber plies.

As an alternative or in addition, it may also be provided that at least one covering fiber ply has a smaller ply thickness than or the same ply thickness as one of the reparative fiber plies in the repair cavity. This covering fiber ply preferably has a smaller ply thickness than all of the reparative fiber plies in the repair cavity, or the same ply thickness as all of the reparative fiber plies in the repair cavity, provided that all of the reparative fiber plies have the same ply thickness. This makes it possible to have the effect that the closure of the repair cavity by the last covering fiber ply has a more favorable influence on statics, aerodynamics and/or visual appearance. In this case, it may be provided that this property applies to all of the covering fiber plies.

The invention will be explained in more detail and by way of example on the basis of the appended FIGURE, in which:

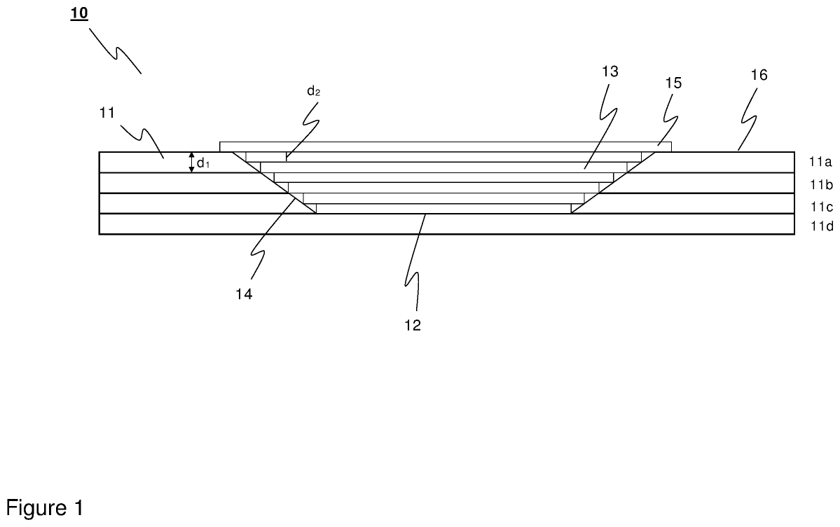

FIG. 1—shows a schematic illustration of a repaired fiber composite component.

FIG. 1 shows a fiber composite component 10, which, for illustrative purposes, comprises only four fiber plies 11 of a fiber material of a fiber composite component. In this case, the four fiber plies are arranged one on top of the other and consolidated by curing a matrix material, in which the fiber material of the fiber plies 11 is embedded, to form an integral unit. In this respect, each of the fiber plies 11 has a main fiber direction which may differ from one fiber ply to another, in order to thus obtain as good as possible a load-bearing property in the entire areal plane of the fiber composite component 10 and to at least approximate the properties of isotropic and anisotropic substances.

Now, the fiber composite component 10 exhibited damage in the first two top fiber plies 11a and 11b of the fiber composite component 10, and therefore it was necessary to repair the fiber composite component 10. For this, a repair cavity 12, which may be produced for example by boring, grinding or milling, was created by removing the damaged point. In the process, the first three top fiber plies 11a, 11b and 11c were removed in the region of the repair cavity 12, in order to thus make space for a corresponding repair patch.

Here, the repair cavity 12 is realized in the form of a scarfing, in which the edge regions are slanted toward the base of the repair cavity.

Reparative fiber plies 13 are now introduced one after the other into the repair cavity 12 thus formed, in order to refill the formed repair cavity 12 with fiber material. The reparative fiber plies 13 that were introduced into the repair cavity 12 in this respect have a ply thickness d₂ that is smaller than the ply thickness d₁ of the fiber plies 11 of the fiber composite component 10.

The ply thickness of a fiber ply or of a reparative fiber ply is understood here to mean the maximum extent of the fiber material orthogonally to the fiber ply plane of the fiber plies.

On account of the fact that the reparative fiber plies have a smaller ply thickness d₂ than the ply thickness d₁ of the fiber plies 11 of the fiber composite component 10, it is possible to introduce a greater number of reparative fiber plies 13 into the repair cavity 12 than the number of fiber plies 11 of the fiber composite component 10 that were removed from the fiber composite component 10 in the region of the repair cavity 12.

In a schematically idealized form, in FIG. 1 the reparative fiber plies 13 are formed in such a way that two reparative fiber plies 13 placed in the repair cavity 12 correspond to one respective fiber ply 11 of the fiber composite component 10. If it is now the case that these two reparative fiber plies 13, which are assigned to one fiber ply 11 of the fiber composite component 10, have a main fiber direction that varies between these two reparative fiber plies 13, it is possible to have the effect that, in relation to a fiber ply 11 of the fiber composite component 10 at the repaired location, the patch within the repair cavity 12 obtains a better load-bearing property and therefore possible disadvantages of the repair can be compensated.

Furthermore, the effect of the smaller ply thickness d₂ compared to the fiber plies 11 of the fiber composite component 10 is that in the edge region 14 the step effect caused by the adjacent reparative fiber plies 13 is reduced, and as a result of the smaller ply thickness there is a greater ply resolution in the edge region 14. This makes it possible to reduce the volume of resin pockets or adhesive pockets in the edge region 14 of the repair cavity 12, as a result of which it is likewise possible to increase the strength and rigidity of the repair patch.

In the exemplary embodiment of FIG. 1 it is furthermore shown that lastly, as the top covering ply 15, a reparative fiber ply is likewise placed on, the ends of which protrude beyond the repair cavity 12. The covering ply 15 may also have a ply thickness that is smaller than the ply thickness d₁ of the fiber plies 11 of the fiber composite component, as a result of which it is possible to reduce jumps in the outer surface 16 of the fiber composite component. This is especially advantageous in particular in the case of surfaces around which an aerodynamic flow passes, since this makes it possible to reduce the air resistance.

### LIST OF REFERENCE SIGNS

10—Fiber composite component

11—Fiber plies

12—Repair cavity

13—Reparative fiber plies

14—Edge region

15—Covering ply

16—Outer surface

d₁—Ply thickness of the fiber plies 11

d₂ Ply thickness of the reparative fiber plies 13

1. A method for repairing a damaged point of a fiber composite component which is formed from a plurality of fiber plies of a fiber material of a fiber composite substance and a matrix material of the fiber composite substance, in which the matrix material of the fiber material is embedded, comprising:
removing the damaged point from the fiber composite component and producing a repair cavity in the fiber composite component,
introducing at least one reparative fiber ply of a repair fiber material into the repair cavity produced in the fiber composite component, wherein the at least one fiber ply is embedded in a repair matrix material, and
consolidating the matrix material with the repair matrix materialin which the repair fiber material is embedded after introducing the at least one reparative fiber ply into the repair cavity of the fiber composite component,
wherein the at least one reparative fiber ply introduced into the repair cavity has a ply thickness that is smaller than a ply thickness of at least one of the plurality of fiber plies of the fiber composite component.

2. The method as claimed in claim 1, wherein the repair cavity in the fiber composite component is produced by forming a scarfing in a region of the damaged point.

3. The method as claimed in claim 1, wherein the at least one reparative fiber ply comprises a plurality of reparative fiber plies, and wherein the plurality of reparative fiber plies are arranged in a stepped manner in the repair cavity such a way that a second reparative fiber ply of the plurality of reparative fiber plies which is placed on a first reparative fiber ply of the plurality of reparative fiber plies, has a larger extent in at least one direction than the first reparative fiber ply.

4. The method as claimed in claim 1 wherein the at least one reparative fiber ply comprises a plurality of reparative fiber plies, and wherein all of the reparative fiber plies introduced in the repair cavity have a ply thickness that is smaller than the ply thickness of each of the plurality of fiber plies of the fiber composite component.

5. The method as claimed in claim 1 wherein at least one reparative fiber ply is preimpregnated with the repair matrix material, or wherein the repair fiber material is infused with the repair matrix material before or after the introduction of the at least one reparative fiber ply into the repair cavity produced.

6. The method as claimed in claim 1 wherein the ply thickness of the at least one reparative fiber ply is less than 80% of the ply thickness of the at least one of the plurality of fiber plies the fiber composite component.

7. The method as claimed in claim 1 wherein the ply thickness of the at least one reparative fiber ply is less than 100 g/m².

8. The method as claimed in claim 1 wherein the at least one of the plurality of fiber plies of the fiber composite component has a ply thickness of more than 100 g/m².

9. The method as claimed in claim 1 wherein the at least one reparative fiber ply comprises a plurality of reparative fiber plies, and wherein the plurality of reparative fiber plies are introduced into the repair cavity such that the second reparative fiber ply of the plurality of reparative fiber plies which is placed on a first reparative fiber ply of the plurality of reparative fiber plies has a main fiber direction which differs from the first reparative fiber ply.

10. The method as claimed in claim 9, wherein the main fiber direction differs by an angle of +/−30°.

11. The method as claimed in claim 1 further comprising placing one or more covering fiber plies onto the at least one reparative fiber ply introduced in the repair cavity.

12. The method as claimed in claim 11, wherein at least one of the one or more covering fiber plies has a larger extent than the repair cavity in at least one direction, and/or wherein at least one of the one or more covering fiber plies has a ply thickness that is smaller than or equal to the at least one reparative fiber ply of the repair cavity.

13. The method as claimed in claim 1 wherein the ply thickness of the at least one reparative fiber ply is less than 60% of the ply thickness of the at least one of the plurality of fiber plies of the fiber composite component.

14. The method as claimed in claim 1 wherein the ply thickness of the at least one reparative fiber ply is less than 40% of the ply thickness of the at least one of the plurality of fiber plies of the fiber composite component.

15. The method as claimed in claim 1 wherein the ply thickness of the at least one reparative fiber ply is less than 75 g/m².

16. The method as claimed in claim 1 wherein the ply thickness of the at least one reparative fiber ply is less than 50 g/m².

17. The method as claimed in claim 1 wherein the at least one of the plurality of fiber plies of the fiber composite component has a ply thickness of more than 135 g/m².

18. The method as claimed in claim 9 wherein the main fiber direction differs by an angle of +/−45°.

19. The method as claimed in claim 9 wherein the main fiber direction differs by an angle of +/−60°.

20. The method as claimed in claim 9 wherein the main fiber direction differs by an angle of +/−90°.
